(19) United States
(12) Patent Application Publication
(10) Pub. No.: US 2006/0123099 A1
(43) Pub. Date: Jun. 8, 2006

(54) Enhanced electronic service guide container

(75) Inventors: Toni Paila, Degerby (FI); Topi Pohjolainen, Helsinki (FI); Jani Poikela, Helsinki (FI); Juhani Huttunen, Veikkola (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/007,048

(22) Filed: Dec. 8, 2004

(51) Int. Cl. G06F 15/16

(52) U.S. Cl. 709/219

(57) ABSTRACT

The invention provides an efficient transportation of ESG fragments to a receiver through the formation of containers. In this sense, a container comprises at least one ESG fragment, but may contain a plurality of fragments. A fragment may be also carried in more than one container. Aspects of the present invention utilize a simple and extensible header structure apart from the fragments independent of the type and format of the individual fragments. In further embodiments, compression is applied over the entire container, including the fragments and any headers. In yet further embodiments, a 3GPP metadata envelope is carried within the container without the need for unnecessary repetition of parameters, such as for example, version, validity time, and identification. In further embodiments, a simplified container system allowing for the updating of previously received fragments is disclosed

The present application is a continuation-in-part of co-pending application entitled “Enhanced Electronic Service Guide Container,” filed Dec. 2, 2004 and assigned attorney docket number 004770.00311, the entire disclosure of which is hereby incorporated by reference.

### FIELD OF THE INVENTION

The invention relates generally to communications networks. More specifically, the invention relates to the signaling of an aggregate of data within a broadcast system.

### BACKGROUND OF THE INVENTION

Generally, an Electronic Service Guide (ESG) enables a terminal to communicate what services are available to end users and how the services may be accessed. ESG fragments are independently existing pieces of the ESG. Traditionally, ESG fragments comprise XML documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data comprising the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One example used in digital video broadcasting (DVB) streams is an electronic program guide (EPG). One type of DVB is Digital video broadcasting-handheld (DVB-H), a recently developed technology that increases the capabilities and services available on small handheld devices, such as mobile telephones. The DVB-H is designed to deliver 10 Mbps of data to a battery-powered terminal device.

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetised data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, is incorporated into the TS. This enables a receiver device to correctly process the data contained within the TS.

The present invention, however, is also is applicable to other traditional digital mobile broadcast systems such as, for example, T-DAB, T/S-DMB, ISDB-T, ATSC, MediaFlow, and non-traditional systems such 3GPP MBMS (Multimedia Broadcast/Multicast Services) and 3GPP2 BCMCS (Broadcast/Multicast Service).

As image and other large files predominate the ESG transport, there exists a need to efficiently transport the ESG fragments across the desired networks to the end receivers. Previous systems transmitted a header before the ESG, however, this is quite inefficient because if containers carrying ESGs are transmitted before the header, the information is inaccessible until the header arrives and there is the risk of not receiving the header, thereby rendering the information in the container useless. Current attempts focus on associating several fragments together; however, these attempts have been largely unsuccessful due to the lack of unique identification of the fragments, an efficient header or indexing structure, or requiring the presence of repetitive parameters.

### BRIEF SUMMARY OF THE INVENTION

Aspects of the present invention allow for the efficient transportation of ESG fragments to a receiver through the formation of containers. In this sense, a container comprises at least one ESG fragment, but may contain a plurality of fragments. Alternatively, a fragment may be carried in more than one container. The containers are transported to the receiver, for example, by using Asynchronous Layer Coding (ALC)/Layered Coding Transport (LCT) such that a single ALC/LCT transport object corresponds to a single container. The fragments can be utilized by the receiver upon reception of the entire container. Aspects of the present invention utilizes a simple and extensible header structure apart from the fragments independent of the type and format of the individual fragments. In further embodiments, compression is applied over the entire container, including the fragments and any headers. In yet further embodiments, other envelopes, e.g. a 3GPP metadata envelope may be carried within the container without the need for unnecessary repetition of parameters, such as for example, version, validity time, and identification.

Metadata within a 3GPP (3rd Generation Partnership Project) envelope or in any other form may include specific channels, specific programs, and/or specific channel bundles. Other types of metadata may include: package data, purchase data, such as operator identity data and technical data for performing the transaction, e.g., an address, protocol, price data which may be based upon package/day, channel/minute, program/minute; channel data, such as a textual description for a user, content provider branding information/logo, classification and rating data, such as genre and parental rating, channel SDP data, such as a description of capabilities needed to use the service, e.g., audio and video format and bit rate information, start and end time, addresses, addresses of synchronized auxiliary data feeds, proprietary extensions; and program data, such as a textual description for a user, start and end times, references for interactive services related to the program. This metadata may be loaded by an operator or may be performed automatically.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of a wireless communication system in which various aspects of the present invention may be implemented.

FIG. 2 illustrates a block diagram of a mobile terminal in accordance with an aspect of the present invention.

FIG. 3 illustrates a schematic diagram of an example transport object in accordance with an aspect of the present invention.

FIG. 4 illustrates a method of transporting a multitude of single object transports in accordance with an aspect of the present invention.

FIG. 5 illustrates a block diagram of exemplary electronic service guide (ESG) fragment descriptor entries in accordance with at least one aspect of the present invention.

FIG. 6 illustrates a block diagram of an exemplary container having a plurality of ESG objects in accordance with at least one aspect of the present invention.

FIG. 7 is a block diagram illustrating further exemplary frames of electronic service guide (ESG) fragment descriptor entries in accordance with at least one aspect of the present invention.

FIG. 8 is a block diagram of a simplified container system in accordance with one embodiment of the present invention configured for the updating of previously received fragments.

FIG. 9 is a block diagram illustrating the container and fragment management in an updating system in accordance with one embodiment of the invention.

FIG. 10 is a block diagram illustrating a container update performed in accordance with one embodiment of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

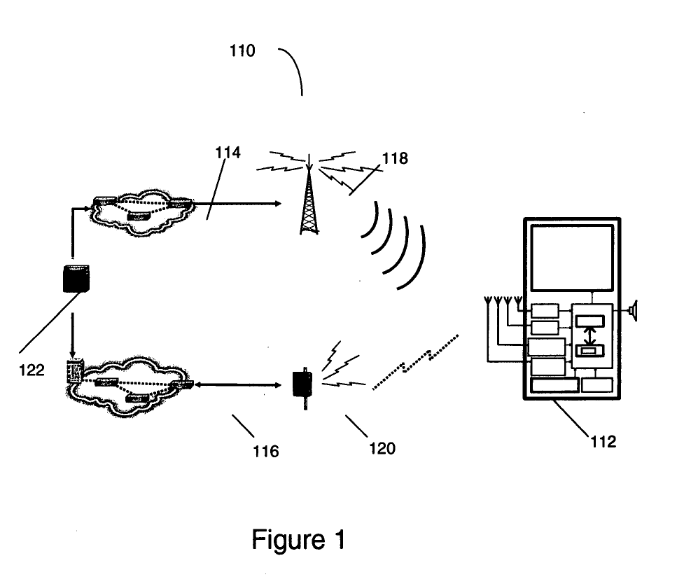

The present invention may be utilized across a broad array of networks and communication protocols. FIG. 1 illustrates an example of a wireless communication system 110 in which the systems and methods of the invention may be employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 and/or cellular network 116. The mobile terminal/device 112 may comprise a digital broadcast receiver device. The service source 122 may be connected to several service providers that may provide their actual program content or information or description of their services and programs to the service source that further provides the content or information to the mobile device 112, which may be used and/or displayed as an electronic service guide for user to select their services and programs. The several service providers may include but are not limited to one or more television and/or digital television service providers, AM/FM radio service providers, SMS/MMS push service providers, Internet content or access providers.

The broadcast network 114 may include a radio transmission of IP datacasting over DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116.

The mobile device 112 may also contact the service source 122 through the cellular network 116. The cellular network 116 may comprise a wireless network and a base transceiver station transmitter 120. The cellular network may include a second/third-generation (2G/3G) cellular data communications network, a Global System for Mobile communications network (GSM), or other wireless communication network such as a WLAN network.

In one aspect of the invention, mobile device 112 may comprise a wireless interface configured to send and/or receive digital wireless communications within cellular network 116. The information received by mobile device 112 through the cellular network 116 or broadcast network 114 may include user selection, applications, services, electronic images, audio clips, video clips, and/or other messages. As part of cellular network 116, one or more base stations (not shown) may support digital communications with receiver device 112 while the receiver device is located within the administrative domain of cellular network 116.

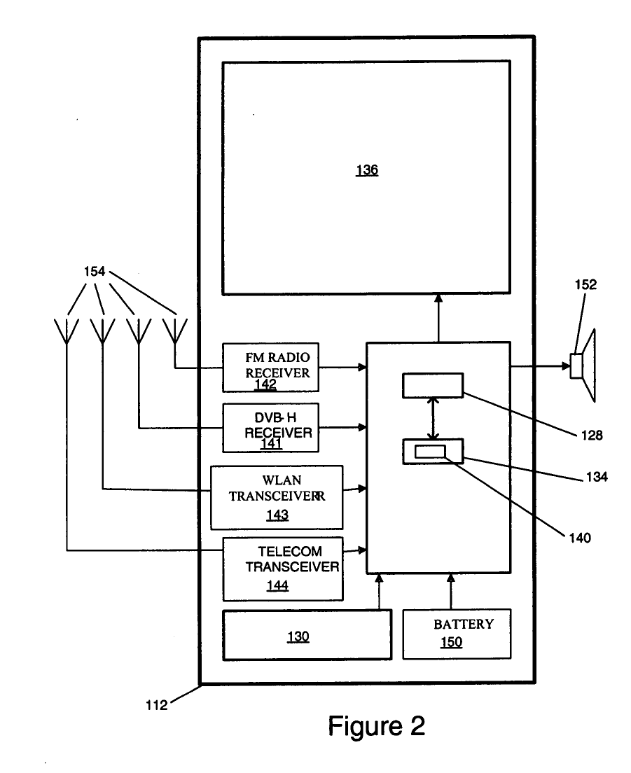

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, one or more arrow keys, joy-stick, data glove, mouse, roller ball, touch screen, voice interface, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory and optionally being detachable. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process transmissions based on the Digital Video Broadcast (DVB) standard, such as DVB-H or DVB-MHP, through a specific DVB receiver 141. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting) or DIRECTV. Additionally, the digital transmission may be time sliced, such as in DVB-H technology. Time-slicing may reduce the average power consumption of a mobile terminal and may enable smooth and seamless handover. Time-slicing consists of sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

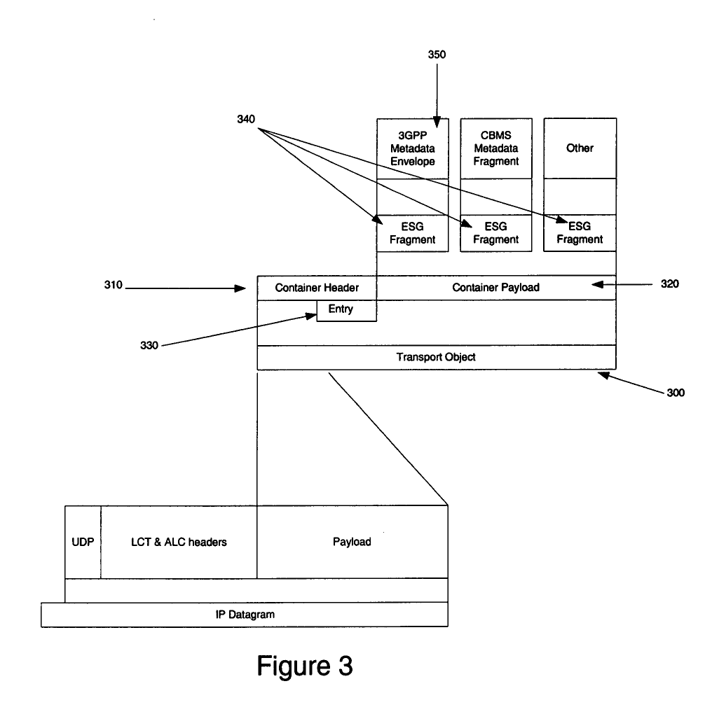

FIG. 3 is a schematic diagram of an example transport object in accordance with at least one aspect of the present invention. Generally, a single transport object 300 comprises a container header 310 and a container payload 320. By incorporating the header 310 and the payload 320 into a single object 300, there is no longer a need to recombine each header with the information regarding where each container is located within different transported objects. Furthermore, there is no longer an issue of which to transmit first, as presented in previous systems. The container header 310 may contain configuration information regarding the header and/or the container payload 320. In one embodiment, the header 310 is coded to inform a receiver of the entry length of the header.

In the exemplary embodiment, the header 310 may have a plurality of ESG fragment descriptor entries 330 that identify the ESG fragments 340 in the container payload 320 so that the receiver may determine the exact position and/or length of each contained ESG fragment 340. For example, in one embodiment, a field specifies where the particular ESG begins within the container payload 120 by providing, for example, an offset value 550, start and end points, or the like. In other embodiments, metadata 350 may be associated with the individual ESG fragments 340, located within or proximate to the header 310, descriptor entries 330, a ESG fragment 340 or a mixture thereof. In one exemplary embodiment, the association of a 3GPP metadata envelope with an ESG fragment 340 may substitute for, or negate the need of additional metadata to be located in the header 310 in relation to that particular ESG fragment.

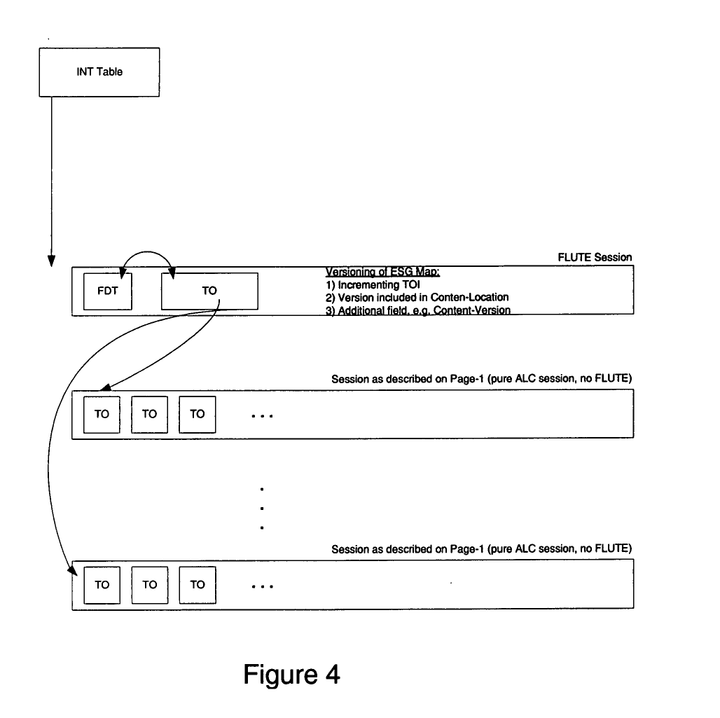

FIG. 4 illustrates a method of transmitting a multitude of single object transports wherein the transports are in accordance with at least one aspect of the present invention. As illustrated in FIG. 4, the transports objects (TO) of the current invention may be carried in, for example, FLUTE (File Delivery over Unidirectional Transport) sessions, or a pure ALC session. In the example of FIG. 4, the ESG Root Channel data, such as IP Address, port number and Transport Session Identifier (TSI), are announced in the IP/MAC Notification Table (INT Table). The FLUTE session of the ESG Root Channel comprises a File Delivery Table of the said session and one or more Transport Objects (TO). These Transport Objects contain mapping between the different types of ESGs and access parameters to the different ESG sessions in which the ESG data is transmitted. The ESGs may differ from each other e.g. as being in different languages and/or having different encoding or genre. The access parameters include IP Addresses, port numbers, TSIs, start and end times etc. The FLUTE session thus declares how the ESG data is distributed to different sessions. The TOs of the FLUTE session carrying this mapping data are described in the FDT of the FLUTE session. The ESG mapping data may be delivered in one or multiple TOs. The mapping can be made using XML Schema, plain ASCII text, Structured ASCII text such as multipart MIME or MIME headers, as binary with enumerated types or through various other means as is known in the art. The ESG data is in this example delivered in ESG sessions, which may be pure ALC sessions, in one or more TOs. The same ESG data may be delivered in one or more ESG sessions. The ESG data or parts of it may be delivered in some embodiments of the invention in one or more FLUTE sessions in addition to or instead of ALC sessions.

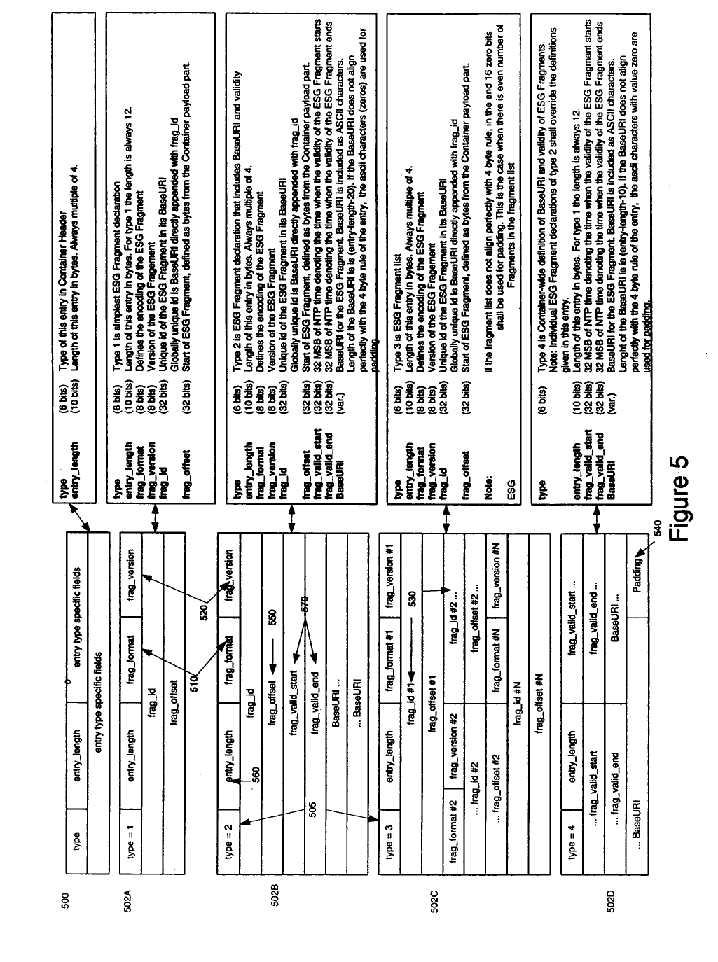

FIG. 5 is a block diagram illustrating exemplary frames of electronic service guide (ESG) fragment descriptor entries in accordance with at least one aspect of the present invention. Frame 500 illustrates a format of the protocol frame for a header 310. The frames having descriptor entries 502A-D are exemplary instantiations which include a type field 505 to indicate the type and features of an entry 330. The type field may be extensible to allow for the addition of new types of entries. By inputting an entry type into this field 505, different information is available to the receiver. Frame instantiations 502A-D we have pre-defined specific metadata associated with fragments. For example in 502B, the fields offset, start, end and baseURI are metadata for the corresponding fragment in the payload. Frame instantiation 502C in turn doesn't associate any metadata with the fragment it represents.

As described above, the payload may contain an envelope which associates metadata with the fragment itself (both included in the envelope) or indicate that metadata is located in the header, or alternatively the type is an entry that provides predefined parameters of the ESG fragments located within the payload. Furthermore, as shown by frame 502C, a single descriptor entry may be configured by its type to describe a plurality of ESG fragments, or even different versions of the same ESG fragment. For example, frame 502A is flagged as a type 1 entry, and includes information regarding the ESG fragments such as location, format, version information, a unique identifier. To illustrate this point, frames 502 may provide additional information fields regarding the ESG fragments 340, such as format 510, version 520, and a unique identifier 530. In the exemplary embodiment, the format field 510 specifies whether an ESG fragment 500 is text, a video, and/or a picture. One skilled in the art, however, will realize that the format field 510 could specify virtually any information concerning the type of media contained in the ESG fragment 340.

A version field 520 may be included to allow the updating of previously received ESGs. For example, a newer version of an ESG can be automatically detected and executed, whereas an outdated ESG fragment as specified by the version field 520 may not be executed or may be executed at the discretion of the user of the receiver. This is also often useful where local services are available. For example, when a mobile terminal moves from one geographical area to another geographical area, some services may remain available, some may no longer be available, and some may become available. Therefore, some of the ESG objects are valid in the new geographical area as in the old geographic area. In an embodiment, a terminal may identify those ESG objects which are valid in the new geographic area and may store/cache objects that are no longer valid. In another embodiment, a terminal may receive and store ESG objects from different frequencies, IP platforms, and network operators and then combine these objects with ESG objects from the current network into a unified ESG.

Optionally, a version field 520 may be coupled with or replaced by a validity field 570. While the version field 520 may indicate whether the received ESG fragment is the most current version or is configured to determine if compatibility issues exist, a validity field 570 may further separate useless or less prioritized ESG fragments. As illustrated in FIG. 5, one or more validity fields 570 may indicate time periods at which the associated fragment is valid. Alternatively, validity may be based on the receiver's hardware, user defined settings, and/or the presence of other ESGs. By way of example, the presence of a BaseURI or location where the node was loaded, whether in the validity field 570, or another field, can permit verification of a received ESG fragment. In other embodiments, a BaseURI may allow the receiver to utilize the information located at the URI in conjunction with or in place of the ESG fragment.

A unique identifier field 530 allows for the identification of an ESG fragment irregardless of the information in the container header 310. Such information would, for example, be useful when several ESGs are received, executed, or otherwise no longer associated with the header or otherwise need to be universally identifiable. Each of the above information fields 510, 520, 530, among other utilized fields may optionally contain a padding field 540 to compensate for improper alignment with the byte rules of the entries. For example, if the location of an ESG fragment contains a BaseURI that does not supply enough bits for the entry, ASCII characters, such as zero, may be used to fill the needed spaces to fulfill the bits requirement. As disclosed, each ESG fragment may be coded for a different bit rate than other ESG fragments. In yet further embodiments, different bit rates may be utilized for different parameters within a single ESG, for example, in the different information fields 510, 520, 530.

Location of an ESG fragment may be obtained by utilizing an offset field 550 alone or in conjunction with an entry length field 560, wherein the fragment's offset can be measured from the header, an initial point within the payload, or any other point within the transport object. The fragment offset and length value can be measured in bits, bytes, or any like quantifying system. As previously discussed, fields utilizing different systems (ie. 6 bit, 10 bit, 32 bit) can all be can encoded within the same descriptor entry. Each descriptor entry 500 has a fragment identification field 530 which uniquely identifies the ESG fragment. In the exemplary descriptor entries 500C, 500D, 500E, the BaseURI is appended to the fragment's identification within the payload container to create a globally unique identifier.

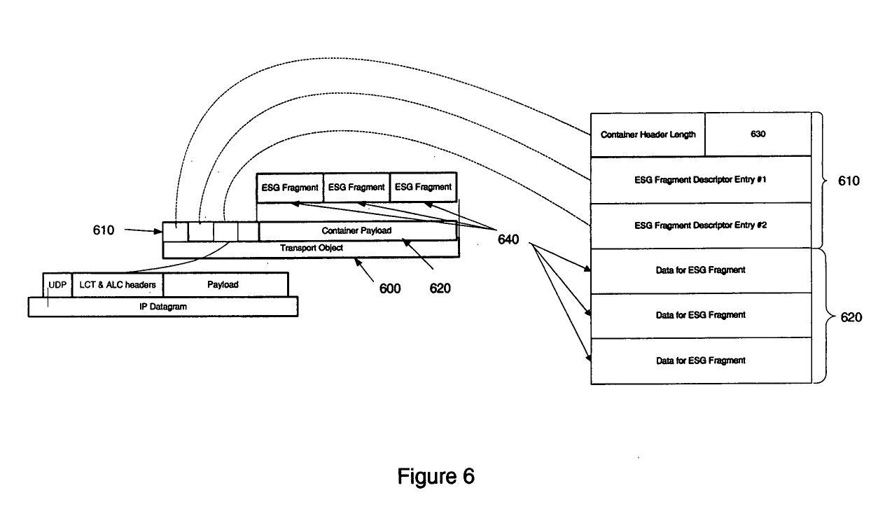

FIG. 6 illustrates a block diagram of an exemplary container having a plurality of ESG fragments in accordance with at least one aspect of the present invention. The transport object 600 has a container header 610 preceding a container payload 620, together forming a single transport object. The header 610 comprises a coding section regarding the header length 630. The header 610 may optionally contain a signaling mechanism or a transport encoding mechanism that is configured to signal that the transport object or a portion thereof is encoded or otherwise compressed. In one embodiment, an LCT codepoint, located in the beginning of the header 610, can signal that the entire transport including the header is compressed. In other embodiments, a reserve field may comprise a codepoint that signals the encoding for the transport object 600. By way of example, GZIP may be used for this purpose; however, one skilled in the art will recognize that numerous other alternatives will accomplish the goal of compression in this manner. In embodiments having a reserved field, additional information may optionally be included that relates, for example, to the ESGs, the header itself, or additional compression or encoding information. The container payload 620 comprises at least one ESG fragment 640, with some or all of the fragments having metadata (see FIG. 3). In some instances, the fragments do not have metadata, rather any requisite metadata is found in the header 610 associated with the appropriate descriptor entry. The transport object may be stored in a memory at the transmitter, intermediate transmission nodes, and/or in the various receivers.

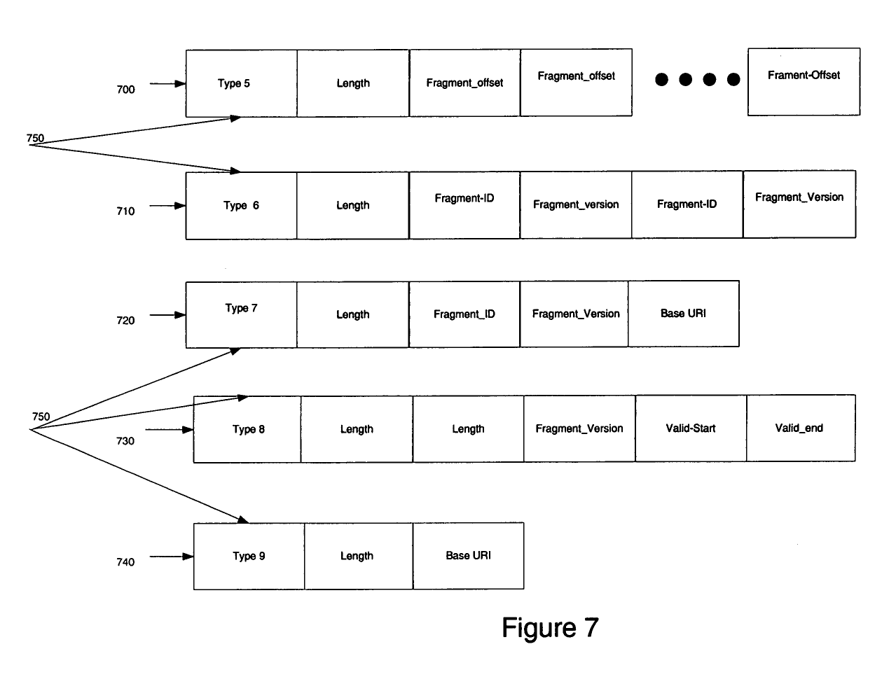

FIG. 7 is a block diagram illustrating further exemplary frames of electronic service guide (ESG) fragment descriptor entries in accordance with at least one aspect of the present invention. The frames 700, 710, 720, 730, and 740 include a type field 750 to indicate the type of frame received. As discussed above, the type field 750 may be extensible to allow for the addition of new types of entries. Frame 700 illustrates a simple ESG descriptor entry that provides the position of ESG fragments in the payload. In the illustrated embodiment, an offset value of the ESG fragment is utilized to locate the fragments.

Frames 710, 720, and 730 illustrate the various types of descriptor entries that do not associate with any container payload. Rather, frames 710, 720, and 730 may be used to validate ESG fragments already received. In further embodiments, such as illustrated by frame 740, the descriptor entry may comprise a declaration of a BaseURI for the entire container.

In yet another aspect, the invention comprises a system and method of using the same to determine whether a newly transmitted container is a valid update of a previously received container without the need to decode or otherwise process the information within the container payload. In at least one embodiment, a transmitter is configured to update numerous fragments as a single unit. The transmitted container may be further configured to mandate all targeted fragments are updated. It yet still another aspect, the invention comprises a system and method of using the same that only requires a single instance of a container type to determine the combination of fragments in each other possible instance of the same type.

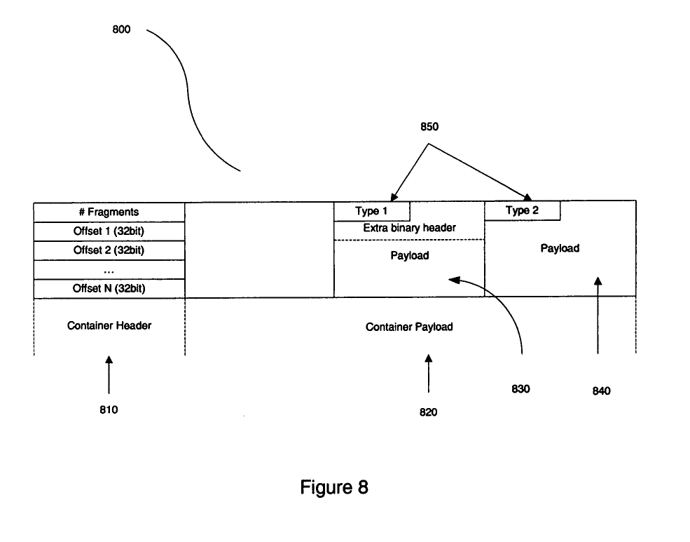

FIG. 8 is a block diagram of a simplified container system in accordance with one embodiment of the present invention configured for the updating of previously received fragments. The system is configured to determine whether the newly transmitted container is a valid update without the need to decode or otherwise read the information within the container payload. An update container 800 generally comprises a container header 810 and a container payload 820. In the exemplary embodiment, the header 810 contains information relating the number of fragments in the payload 820 and the associated offset values, however, it is within the scope of the invention to include information relating to the header 810 and/or payload 820. The payload comprises data items 830, 840 having fragment updates. While the embodiment shows two data items, additional data items are contemplated as well as transmitting a single data item. Each data item includes an indication of its type 850.

The container may further indicate the presence of a payload header. For example, a type 1 data item could be a binary envelope having metadata in a header as illustrated, being associated with predetermined fragments. Type 2 may indicate a 3GPP textual envelope associated with different fragments. The metadata therefore, is not fixed on the transport level. In addition to these examples, other container types may be defined.

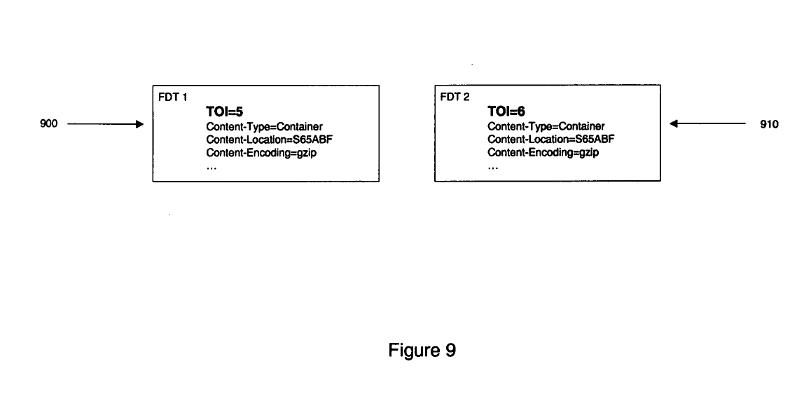

The novel updating system is implemented through the configuration and management of the fragments and container instances. An “instance of fragments” or “fragment instance” concerns a fragment with specific type and version, wherein an “instance of a container” or “container instance” concerns a container holding specific instances of fragments. FIG. 9 is a block diagram illustrating the container and fragment management in an updating system in accordance with one embodiment of the invention. In the exemplary embodiment, File Delivery Tables (FDT) 900 and 910 announce the instantiations of the grouping of fragments. The fragment types in each container type are determined by the receiver when initially receiving the first container instance. All different container instances of the same type use the same signature, for example FDT Content-Location, but a different transfer object identifier (TOI). In the exemplary embodiment, FDT 900 has a TOI=5 and FDT 910 has a TOI=6, thereby indicating a different container instance, however, the Content Type and Content-Location remain unaltered. Two different container instances may have different encoding applied, i.e. they have different Content types. For example a container holding fragments A of version A1 and B of version B1 and a container holding fragments A of version A2 and B of version B2 have the same container type. Additionally, a container holding fragment A (irregardless of the version) will have a distinctly different container type than a container holding fragments A, B and C (of any version). Additional optional fields, such as Content-Encoding can also remain in an unaltered state depending on the transmitter's preference. For example, if textual metadata is utilized, the entire container may be encoded with for example, GZip or other mechanisms known in the art. Alternatively only portions could be encoded.

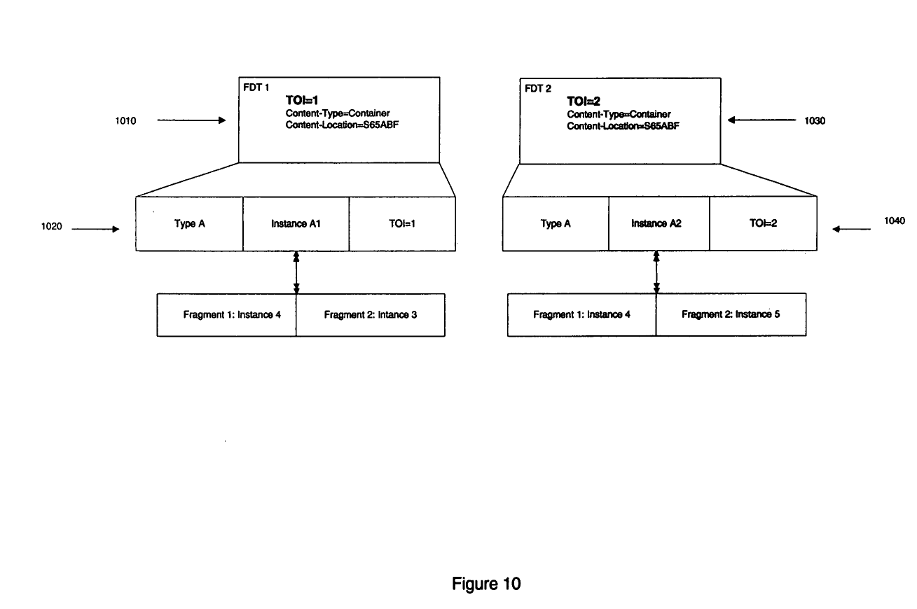

Container encoding and Forward Error Correction (FEC) can be declared by different mechanisms. For example, FDT parameters may declare the encoding mechanism. In one embodiment, the encoding and FEC are declared through the use of LCT extensions. The containers are encoded to enable the receiver to determine if the container is to be decoded and processed without having to access or otherwise read the containers. FIG. 10 is a block diagram illustrating a container update performed in accordance with one embodiment of the invention. In the example, FDT 1010 has a TOI=1 and corresponds to a Type A container 1020 having an instance A1, wherein instance A1 may comprise for example fragment 1: instance 4 and fragment 2: instance 3. The FDT 1010 and the associated container 1020 are received at a terminal, where they are processed or rejected. The File Delivery Table 1030, represents an update to FDT 1010, and is received after the receipt of FDT 1010. FDT still corresponds to a Type A container 1040, however it includes instance A2 in place of instance A1, and may comprise changes such as, for example, fragment 1: instance 4 is not changed, but fragment 2: instance 3 is changed to instance 5. Upon receipt, the terminal determines that instance A2 includes one or more fragment updates as compared to instance A1. The terminal may further determine that A2 contains the same type of fragments as A1. In one embodiment, the terminal further determines, based on a myriad of factors, whether A2 is to be implemented.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A memory comprising a single transport object for signaling an aggregate of data items, the memory comprising:
a container payload comprising at least two data items; and
a container header having an extensible structure, the container header including a container header length and data item descriptor entries, the ESG fragment descriptor entries configured to provide information regarding the location of the associated data item within the payload.

2. The memory of claim 1, wherein the data item is an ESG fragment.

3. The memory of claim 1, wherein the data item descriptor entries further include metadata for at least a portion of the data items within the payload.

4. The memory of claim 1, wherein the data items are assigned a unique identification code.

5. The memory of claim 1, further comprising a transport encoding mechanism.

6. The memory of claim 1, wherein each descriptor entry is classified dependent on the presence of metadata in the header.

7. The memory of claim 1, wherein a portion of the data items incorporates metadata.

8. The memory of claim 1, wherein one descriptor entry describes a plurality of data items.

9. The memory of claim 4, wherein the unique fragment identification is configured by declaring a BaseURI to which the data item is appended.

10. The memory of claim 4, wherein the unique fragment identification is configured by declaring a BaseURL to which the data item is appended.

11. The memory of claim 9, wherein the transported BaseURI permits verification of the received data item.

12. The memory of claim 9, wherein the transported BaseURI permits the receiver to utilize the information located at the URI in conjunction with the data item.

13. The memory of claim 9, wherein the transported BaseURI permits the receiver to utilize the information located at the URI in place of the data item.

14. The memory of claim 1, wherein the transport encoding mechanism includes an LCT header codepoint that signals the memory has been transport encoded.

15. The memory of claim 6, wherein the transport encoding mechanism includes a reserved field codepoint located in the beginning of the container header that signals the encoding for the entire container.

16. The memory of claim 1, wherein a metadata envelope is coupled to the data item, said envelope containing metadata configured to override the container header.

17. The memory of claim 16, wherein the metadata envelope is a 3GPP envelope.

18. The memory of claim 1, wherein a data item is carried in at least two containers.

19. A mobile terminal for receiving ESG fragments of an electronic service guide, the mobile terminal comprising:
a processor;
a display; and
memory comprising a single transport object for signaling an aggregate of the ESG fragments, the memory comprising:
a container payload comprising the ESG fragments; and
a container header having an extensible structure, the container header including a container header length and ESG fragment descriptor entries, the ESG fragment descriptor entries configured to provide information regarding the location of the associated ESG fragments items within the payload.

20. The mobile terminal of claim 19, wherein the ESG fragment descriptor entries further include metadata for at least a portion of the ESG fragments within the payload.

21. The mobile terminal of claim 19, wherein the ESG fragments are assigned a unique identification code.

22. The mobile terminal of claim 21, wherein the unique fragment identification is configured by declaring a BaseURI to which the ESG fragment is appended.

23. The mobile terminal of claim 21, wherein the unique fragment identification is configured by declaring a BaseURL to which the ESG fragment is appended.

24. The memory of claim 22, wherein the transported BaseURI permits verification of the received ESG fragment.

25. The mobile terminal of claim 22, wherein the transported BaseURI permits the receiver to utilize the information located at the URI in conjunction with the ESG fragment.

26. The mobile terminal of claim 22, wherein the transported BaseURI permits the receiver to utilize the information located at the URI in place of the ESG fragment.

27. The mobile terminal of claim 19, wherein a metadata envelope is coupled to the ESG fragment, said envelope containing metadata configured to override the container header.

28. The mobile terminal of claim 27, wherein the metadata envelope is a 3GPP envelope.

29. The mobile terminal of claim 19, wherein an ESG fragment is carried in at least two containers.

30. A method of receiving an ESG fragment of an electronic service guide in a mobile terminal, the mobile terminal comprising a processor, a display, and memory, the method comprising the steps of:
receiving a single transport object, the single transport object including a container payload and a container header, the container header including a container header length and ESG fragment descriptor entries, and
displaying the container payload on the display of the mobile terminal device.

31. The method of claim 30, wherein the ESG fragment descriptor entries further include metadata.

32. The method of claim 30, wherein the ESG fragment is assigned a unique identification code.

33. A computer readable medium having computer readable instructions for performing the steps of:
receiving a single transport object, the single transport object including a container payload and a container header, the container header including a container header length and ESG fragment descriptor entries, and
interpreting the container payload information.

34. The computer readable medium of claim 33, wherein the ESG fragment descriptor entries further include metadata.

35. The computer readable medium of claim 33, wherein the ESG fragment is assigned a unique identification code.

36. In a mobile terminal having a graphical user interface including a display and a user interface device, a method of receiving an ESG fragment of an electronic service guide in a mobile terminal, the method comprising the steps of:
receiving a single transport object, the single transport object including a container payload and a container header, the container header including a container header length and ESG fragment descriptor entries, and
displaying the container payload on the display of the mobile terminal device.

37. A method of processing a container update at a receiver, the method comprising the steps of:
(a) receiving a data item that identifies a container type and a transport object identifier; wherein the transport object identifier specifies a container instance; and
(b) utilizing the transport object identifier in the data item to determine whether the container has updates to a previous container, wherein the previous container is the same container type as the received container.

38. The method of claim 37, further comprising the steps of:
determining if the received container type has previously been received, wherein upon the first reception of a container type, the combination of fragments is determined, and wherein upon subsequent receptions of the same container type, the types of fragments within the container are available without redetermination.

39. The method of claim 38, wherein the receiver concludes that a container type has been previously received, further comprising the steps of:
determining if the update is to be implemented, wherein the determination occurs previous to the reception and decoding of the container.

40. The method of claim 39, further comprising the step of:
configuring a container to require the receiver to update according all of the fragments enclosed in the container.

41. A memory comprising a single transport object for signaling an aggregate of ESG fragments, the memory comprising:
a container header having an extensible structure, the container header including a container header length and ESG fragment descriptor entries, the ESG fragment descriptor entries configured to provide information regarding the location of the associated ESG fragments within the payload; and
a container payload comprising at least one ESG fragment; the containers further providing an indication to a receiver of its container type, wherein the container type is determined by the combination of enclosed fragments without regard to the version of the enclosed fragments.

42. The memory of claim 41, wherein the container payload further includes a header, wherein the payload header has metadata

43. The memory of claim 42, wherein a metadata envelope is coupled to the fragment, said envelope containing metadata configured to override the container header.

44. The memory of claim 43, wherein the metadata envelope is a 3GPP envelope.
